(19) United States
(12) Patent Application Publication
(10) Pub. No.: US 2005/0263202 A1
(43) Pub. Date: Dec. 1, 2005

(54) Polymeric fuel system components

(76) Inventor: Paul P. Cheng, Washington, WV (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/132,844

(22) Filed: May 19, 2005

Related U.S. Application Data
(60) Provisional application No. 60/572,735, filed on May 20, 2004.

(51) Int. Cl. F16L 11/00

(52) U.S. Cl. 138/137; 138/DIG. 7; 428/36.92

(57) ABSTRACT

A polymeric fuel system component made from a polyamide composition comprising one or more of polyamide 6,10 and polyamide 6,12 or copolymers thereof; stainless steel fibers and/or carbon nanotubes; an impact modifier; a plasticizer; and, optionally, other additives.

### CROSS REFERENCE TO RELATED APPLICATIONS

This application claims priority of U.S. Provisional Application No. 60/572,735, filed May 20, 2004.

### FIELD OF THE INVENTION

The present invention relates to components for use in motor vehicle fuel systems. More particularly the present invention relates to such components made from electrically conductive polyamide compositions comprising one or more of polyamide 6,12 and polyamide 6,10; one or more of stainless steel fibers and carbon nanotubes; an impact modifier; and a plasticizer.

### BACKGROUND OF THE INVENTION

The components used in conveying fuel in motor vehicle fuel systems have traditionally been made from metals. However, it is desirable to make such components from polymeric materials because of their light weight and ability to be formed into intricate parts. The use of polymeric materials also allows for significant flexibility in part design change, as mold designs may be easily altered. Polymeric materials can also easily be formed into seamless articles that have lower likelihoods of leaking than articles containing seams. Suitable polymeric materials will have several desirable properties. It is desirable that polymeric fuel system components that are in direct contact with the fuel have good permeation resistance to the fuel and do not degrade in the presence of the fuel. It is desirable that components, and in particular, those that are exposed to the exterior of the vehicle, have good impact resistance. Since zinc chloride can be formed on vehicle exteriors, and in particular, on vehicle underbodies, by the reaction of road salt with galvanized steel vehicle body parts, it is desirable that the fuel line components be made from polymeric materials that retain their mechanical integrity when exposed to zinc chloride, which is known to cause cracking in certain polymeric materials. Since buildup of electrostatic charge on fuel system components is undesirable, it is also desirable that the polymeric materials be electrically conductive so that they may be grounded. Since fuel system components present in the engine compartment of a vehicle may be exposed to high temperatures, it is necessary that the polymeric materials retain their properties at elevated temperatures.

U.S. Pat. Nos. 5,164,879, 5,164,084, and 5,076,920 describe fuel filters and fuel system components made from electrically conductive nylon 12 compositions. Nylon 12, however, has a relatively low melting point and its fuel permeation resistance decreases upon exposure to elevated temperatures.

It is an object of the present invention to make motor vehicle fuel system components from polymeric materials that have higher melting points, and improved fuel permeation resistance at elevated temperatures than such components fashioned from conventional polymeric materials. Another object of the invention is to provide such fuel system components made from polymeric compositions that are conductive to dissipate static electricity while also suitably withstanding chemical attack associated with road salt, and particularly zinc chloride generated from reaction of the road salt with the galvanized coating on steel underbodies. A feature of the instant invention is its adaptability to form a wide range of fuel system components useful in motor vehicles. These and other objects, features and advantages will become better understood upon having reference to the following description of the invention herein.

### SUMMARY OF THE INVENTION

There is disclosed and claimed herein a fuel system component useful for conveying fuel to an engine of a motor vehicle, and made from a polyamide composition comprising:
(a) about 40 to about 85 weight percent of a polyamide component comprising polyamide 6,10; polyamide 6,12; or copolymers or mixtures thereof,
(b) about 10 to about 30 weight percent of impact modifier,
(c) about 4 to about 20 weight percent of stainless steel fibers, carbon nanotubes, or both, and
(d) about 2 to about 7 weight percent of at least one plasticizer,
   wherein the weight percentages of (a) to (d) are based the total weight of the composition.

### DETAILED DESCRIPTION OF THE INVENTION

By “fuel system component” is meant a component of the fuel system used in a motor vehicle where the component is in direct contact with flowing fuel or has a function of providing a path to ground from a component that is in direct contact with flowing fuel. The components may be part of the fuel tank filling system and the delivery system that conveys fuel from the fuel tank to the engine. The components will preferably be components that have an inner surface that is contact with flowing fuel and an outer surface that is exposed to the vehicle body and/or comprises an exterior surface of the vehicle. By this is meant, the inner and outer surfaces may be two sides of the same surface; or two separate surfaces adjacent to each other. In an alternative embodiment the fuel system components provide a path to ground static electricity but do not typically contact fuel.

The fuel system components may be used in any vehicle possessing an internal combustion engine, such as cars, trucks, motorcycles, all-terrain vehicles, tractors and other farm equipment, construction equipment, and the like.

Preferred components include fuel tank filler pipes and connectors, fuel line connectors, fuel lines and tubing, fuel pump and delivery module components, and fuel filter housings. In an alternative embodiment the preferred components may also include fuel line grounding clips, fuel tank flanges, fuel filter clamps, and fuel tank caps.

The fuel system components of the present invention are made from an electrically conductive polyamide composition comprising at least one polyamide, stainless fibers and/or carbon nanotubes, an impact modifier, and a plasticizer. Other components may optionally be added as will be appreciated to those of skill in this field, and these are included as within the purview of the invention.

The polyamide component used in the composition is polyamide 6,10 (poly(hexamethylene sebacamide)); polyamide 6,12 (poly(hexamethylene dodecanediamide)); or mixtures or copolymers thereof. The polyamide component may optionally comprise up to about 10 weight percent, based on the total weight of the polyamide component, of polyamide 11 (polyundecanolactam), polyamide 12 (polylaurolactam), or mixtures or copolymers thereof. When used, polyamide 11, polyamide 12, or mixtures or copolymers thereof will preferably be present in about 0.5 to about 10 weight percent, based on the total weight of the polyamide component. The polyamide is preferably present in about 40 to about 85 weight percent, or more preferably about 50 to about 80 weight percent, or yet more preferably, about 60 to about 75 weight percent, based on the total weight of the composition.

Carbon nanotubes are also known as “carbon nanofibers,” “buckytubes,” and “carbon nanofibrils” and refer to structures having an outside diameter of less than about 1 micrometer or preferably less than about 0.5 micrometers. They may be made by any method known to those in the art. They may be hollow or solid and may be single-walled or comprise multiple walls. They will preferably have an aspect ratio that is about 100 to about 10,000. The stainless steel fibers may be coated with a polymer such as a polyester and/or polyamide. The stainless steel fibers and/or carbon nanotubes may be added to the composition as a masterbatch in a polymeric carrier such as a polyester or polyamide. The stainless steel fibers and/or carbon nanotubes are preferably present in about 3 to about 20 weight percent, based on the total weight of the composition.

The impact modifier used in the composition may be any impact modifier suitable for toughening polyamide resins. Preferred impact modifiers are carboxyl-substituted polyolefins, which are polyolefins that have carboxylic moieties attached thereto, either on the polyolefin backbone itself or on side chains. By ‘carboxylic moiety’ is meant carboxylic groups such as one or more of dicarboxylic acids, diesters, dicarboxylic monoesters, acid anhydrides, and monocarboxylic acids and esters. Useful impact modifiers include dicarboxyl-substituted polyolefins, which are polyolefins that have dicarboxylic moieties attached thereto, either on the polyolefin backbone itself or on side chains. By ‘dicarboxylic moiety’ is meant dicarboxylic groups such as one or more of dicarboxylic acids, diesters, dicarboxylic monoesters, and acid anhydrides.

The impact modifier will preferably be based an ethylene/α-olefin polyolefin. Diene monomers such as 1,4-hexadiene or dicyclopentadiene may optionally be used in the preparation of the polyolefin. Preferred polyolefins are ethylene-propylene-diene (EPDM) polymers made from 1,4-hexadiene and/or dicyclopentadiene. The carboxyl moiety may be introducing during the preparation of the polyolefin by copolymerizing with an unsaturated carboxyl-containing monomer. Preferred is a copolymer of ethylene and maleic anhydride monoethyl ester. The carboxyl moiety may also be introduced by grafting the polyolefin with an unsaturated compound containing a carboxyl moiety, such as an acid, ester, diacid, diester, acid ester, or anhydride. A preferred grafting agent is maleic anhydride. A preferred impact modifier is an EPDM polymer grafted with maleic anhydride, such as Fusabond® N MF521D, which is commercially available from E.I. DuPont de Nemours & Co., Inc., Wilmington, Del. Blends of polyolefins, such as polyethylene, polypropylene, and EPDM polymers with polyolefins that have been grafted with an unsaturated compound containing a carboxyl moiety may be used as impact modifier.

Suitable impact modifiers may also include ionomers. By an ionomer is meant a carboxyl group containing polymer that has been neutralized or partially neutralized with metal cations such as zinc, sodium, or lithium and the like. Examples of ionomers are described in U.S. Pat. Nos. 3,264,272 and 4,187,358. Examples of suitable carboxyl group containing polymers include, but are not limited to, ethylene/acrylic acid copolymers and ethylene/methacrylic acid copolymers. The carboxyl group containing polymers may also be derived from one or more additional monomers, such as, but not limited to, butyl acrylate. Zinc salts are preferred neutralizing agents. Ionomers are commercially available under the Suryln® trademark from E.I. du Pont de Nemours and Co., Wilmington, Del.

The impact modifier will preferably be present in about 10 to about 30 weight percent, based on the total weight of the composition.

The plasticizer used in the composition will be miscible with the polyamides used in the composition. Examples of plasticizers suitable for use in the present invention include sulfonamides, including N-alkyl benzenesulfonamides and toluenesufonamides. Suitable examples include N-butylbenzenesulfonamide, N-(2-hydroxypropyl)benzenesulfonamide, N-ethyl-o-toluenesulfonamide, N-ethyl-p-toluenesulfonamide, o-toluenesulfonamide, p-toluenesulfonamide. Preferred is N-butylbenzenesulfonamide. The plasticizer is preferably present in about 2 to about 7 weight percent, or more preferably about 2.5 to about 6 weight percent, based on the total weight of the composition.

The composition used in the present invention may optionally further comprise additives such as lubricants, thermal, oxidative, and/or light stabilizers; mold release agents; and colorants. A preferred lubricant is aluminum distearate. When used, the additional additives will preferably be present in up to about 3 weight percent or about 0.01 to about 3 weight percent based on the total weight of the composition.

The polyamide compositions used in the present invention are made by melt-blending the components using any known methods. The component materials may be mixed to homogeneity using a melt-mixer such as a single or twin-screw extruder, blender, kneader, Banbury mixer, etc. to give a resin composition. Or, part of the materials may be mixed in a melt-mixer, and the rest of the materials may then be added and further melt-mixed until homogeneous. The melt-blending of stainless steel fibers is preferably done using a relatively gentle blending technique that does not degrade the average fiber length below about 0.5 to 1 mm.

For example and regarding melt blending of the ingredients, individually controlled loss in weight feeders may be used. For ease and control of feeding, the nylon and the low percentage additive ingredients are typically first dry blended by tumbling in a drum. The mixture is then compounded by melt blending in a twin screw extruder (such as a 57 mm Werner & Pfleiderer co-rotating twin screw extruder) with controlled barrel and die temperatures. All the ingredients may be fed into the first barrel section about half the nylon feed, which may be fed into the sixth barrel section by use of a sidefeeder. Extrusion may be carried out with a port under vacuum, and using regulated screw speeds and total extruder feed rates. The resulting strand is typically quenched in water, cut into pellets, and sparged with nitrogen until cool.

The polyamide compositions may be formed into the fuel system components using any suitable melt-processing technique. Commonly used melt processing methods used for making toughened polyamide resins and known in the art such as injection molding, extrusion, blow molding, injection blow molding, thermoforming and the like are preferred.

Molds are preferably designed with sufficiently wide gate sizes such that the average fiber lengths are maintained above about 0.5 mm. Relatively slow molding injection speeds will preferably be used to maximize the electrical conductivity of the molded fuel system components. The fuel system components can be assembled from two or more parts using any method known in the art, including welding methods such as spin welding.

The fuel system components of the present invention are electrically conductive, have good fuel permeation and impact resistance, and the presence of the impact modifier ensures that they retain good mechanical properties upon exposure to salts such as zinc chloride, calcium chloride, and sodium chloride in a damp environment. The fuel system components will preferably have a surface resistivity of less than about 1×10⁹ Ω/square and/or a volume resistivity of less than about 1×10⁸ Ω·cm for optimal static dissipation.

1. A fuel system component useful for conveying fuel to an engine of a motor vehicle, and made from a polyamide composition comprising:
(a) about 40 to about 85 weight percent of a polyamide component comprising polyamide 6,10; polyamide 6,12; or copolymers or mixtures thereof,
(b) about 10 to about 30 weight percent of impact modifier,
(c) about 4 to about 20 weight percent of stainless steel fibers, carbon nanotubes, or both, and
(d) about 2 to about 7 weight percent of at least one plasticizer,
wherein the weight percentages of (a) to (d) are based the total weight of the composition.

2. The fuel system component of claim 1 wherein said plasticizer is N-butyl benzenesulfonamide.

3. The fuel system component of claim 1 wherein said impact modifier comprises an EPDM polyolefin grafted with maleic anhydride.

4. The fuel system component of claim 1 wherein said impact modifier comprises at least one ionomer.

5. The fuel system components of claim 1 wherein the polyamide component (a) further comprises about 0.5 to about 10 weight percent of one or more of polyamide 11 and polyamide 12, based upon the weight percent of the polyamide component (a).

6. The fuel system component of claim 1 having an inner surface that is in contact with flowing fuel and an outer surface that is exposed to the exterior of the vehicle.

7. The fuel system of claim 6 in the form of a fuel tank filler pipe, a fuel tank filler connector, a fuel line connector, a fuel line, fuel tubing, a fuel pump, a fuel delivery module component, or a fuel filter housing.

8. The fuel system of claim 1 in the form of a fuel line grounding clip, a fuel tank flange, or a fuel tank cap.
